(19) United States
(12) Patent Application Publication
(10) Pub. No.: US 2016/0264166 A1
(43) Pub. Date: Sep. 15, 2016

(54) Portable, Collapsible, Motorized Hand Truck

(71) Applicant: Michael W. Miller, Pearl, MS (US)

(72) Inventor: Michael W. Miller, Pearl, MS (US)

(21) Appl. No.: 14/657,052

(22) Filed: Mar. 13, 2015

(51) Int. Cl. B62B 5/00; B62D 51/06; B62D 51/00

(52) U.S. Cl. CPC B62B 5/0036; B62D 51/005; B62D 51/06; B62B 5/0053

(57) ABSTRACT

A portable hand truck is disclosed having a collapsible frame, the frame being movable between collapsed, storage mode and an expanded, upright mode. The hand truck has wheels disposed at a lower end of the frame, a folding support platform hingedly or rotatably connected to a lower end of the frame, and having a battery, a drive controller, and at least one motor. The motor is mechanically connected to at least one wheel or to an axle of the hand truck, and the motor is electrically connected to the battery and the drive controller. The motor and battery are positioned on a lower part of the frame of the hand truck, proximate the wheels to provide a more compact area for collapsing the frame, as well as to provide a lower center of gravity for the hand truck, thereby making the hand truck more stable.

### TECHNICAL FIELD OF THE INVENTION

This invention relates in general to hand trucks and, in particular, to a portable, collapsible, motorized hand truck.

### BACKGROUND OF THE INVENTION

There are many contexts in which modern persons desire to carry large or heavy items where it is not suitable to employ means such as a truck, fork lift and the like. Such contexts include public parks, beaches, campgrounds and similar places where there are restrictions on vehicular traffic. Hand trucks are a well known means of carrying heavy loads in places where vehicular traffic is not suitable. Typically, hand trucks have a ladder-like frame with a handle at a top end and a set of wheels at the bottom end thereof. A generally perpendicular platform or plate typically extends from the frame proximate the bottom end. The platform is typically used to support objects being transported by use of the hand truck. With a hand truck, the strength of a person is required to provide the motive force to move the load over a desired distance. Pushing or pulling a hand truck, particularly if heavily laden, can be inconvenient. To ease that physical burden, a motorized hand truck is desirable.

Examples of motorized hand trucks are known, but these motorized hand trucks lack the features of being collapsible, portable, and easily transported. For example, U.S. Pat. No. 3,527,314, and No. 5,577,568, disclose motorized hand trucks having a large, fixed frame with a second pair of wheels that are driven by a motor mounted on the fixed frame. While the second pair of wheels provides flexibility to operate the hand truck in either hand-driven or motor-driven modes, the second pair of wheels, along with the large, fixed frame make the hand truck not suitable for being conveniently transported to places like public parks and beaches. Such hand trucks are typically transported by means of a large truck or trailer to a single location (like a warehouse) where the hand truck is employed.

U.S. Pat. No. 2,740,484 and No. 7,137,464 disclose motorized hand trucks having a large, fixed frame with a second pair of wheels, both sets of wheels being driven by a motor that is mounted on the frame. These hand trucks have features that make them capable of climbing stairs by means of the motor driven wheels as the hand truck is held in position by a person. The second set of wheels along with the large, fixed frames of these hand trucks make them not suitable convenient transport in a conventional automobile. Such hand trucks are typically transported by means of a large truck or trailer along with other large items (e.g. a refrigerator) to locations where the operator uses the stair-climbing capability to transport the large item up stairs.

U.S. Pat. No. 7,017,691 discloses a collapsible, hand-operated cart having three wheels with a battery and a motor disposed directly on the base platform that connects the three wheels. Although the cart is disclosed as having an attachable basket, in such a configuration the cart cannot be collapsed for transportation or storage. Also, unlike a hand truck, the cart requires the third wheel for stability, and the basket must be attached to the cart in order to use the cart to transport items. Similarly, U. S. Pat. No. 8,596,389 discloses a motorized, hand-operated cart having a collapsible frame. The cart requires four or more wheels for stability and requires a platform for mounting a basket that is used for transporting items.

There is needed a motor-driven hand truck to provide motive force to move large and heavy items that is also compact and collapsible for ease of transportation and storage. There is additionally a need for such a hand truck to be stable, rugged, and adaptable to multiple transport situations such as the rough terrain of parks and the sandy terrain of beaches.

### SUMMARY OF THE INVENTION

Accordingly, it is an aspect of the present invention to provide a motorized hand truck that is portable and collapsible into a configuration that makes it easily transported and stored.

The foregoing and other aspects of the present invention are achieved by providing a hand truck that has a collapsible frame, the frame being movable between collapsed, storage mode and an expanded, upright mode. The hand truck has at least one wheel disposed at a lower end of the frame, a folding support platform hingedly or rotatably connected to a lower end of the frame, and having a battery, a drive controller, and at least one motor. The motor is mechanically connected to at least one wheel or to an axle of the hand truck, and the motor is electrically connected to the battery and the drive controller. The motor and battery are positioned on a lower part of the frame of the hand truck, proximate the wheel or axle to provide a more compact area for collapsing the frame, as well as to provide a lower center of gravity for the hand truck, thereby making the hand truck more stable.

The foregoing and other aspects of the present invention are further achieved by providing a method of manufacturing a motorized hand truck including providing a collapsible frame, the frame being movable between collapsed, storage mode and an expanded, upright mode. The frame has a lower frame portion proximate the lower end of the frame and an upper frame portion proximate the upper end of the frame that is pivotally or slideably connected to the lower frame portion and a folding support platform hingedly or rotatably connected to the lower end of the frame. The method also includes providing at least one wheel that is connected to the lower frame portion of the frame. The method may include providing means for connecting two wheels to an axle that is connected to the lower end of the frame. The method also includes providing a battery, drive controller, and at least one motor mechanically connected to at least one wheel of the hand truck, with the motor being also connected electrically to the battery and drive controller. As an alternative to said motor being connected to at least on wheel, said motor may be connected to an axle that is connected to the lower frame portion of said frame with a pair of wheels mounted on said axle such that the wheels rotate around a single axis. The motor and battery are positioned on the lower frame portion of the frame of the hand truck, proximate the wheel or axle to provide a more compact area for collapsing the frame, as well as to provide a lower center of gravity for the hand truck, thereby making the hand truck more stable.

Other objects, features and objectives of the invention will be found throughout the following description, drawings and the claims.

### BRIEF DESCRIPTION OF THE DRAWINGS

For a more complete understanding of the features and advantages of the present invention, reference is now made to the detailed description of embodiments of the present invention, examples of which are illustrated in the accompanying drawings in which corresponding numerals in different figures refer to corresponding parts and in which:

FIG. 1 is a perspective view of the motorized hand truck in an expanded, upright mode in accordance with an embodiment of the present invention.

FIG. 2 is a side view of the hand truck of FIG. 1 in an expanded mode.

FIG. 3 is a perspective view of the hand truck of FIG. 1 in the collapsed mode.

FIG. 4 is a perspective view of the hand truck of FIG. 1 in a collapsed mode in accordance with an alternative embodiment of the present invention.

FIG. 5 is an exploded perspective view of a motor and wheel in accordance with an embodiment of the present invention.

### DETAILED DESCRIPTION OF THE PREFERRED EMBODIMENT

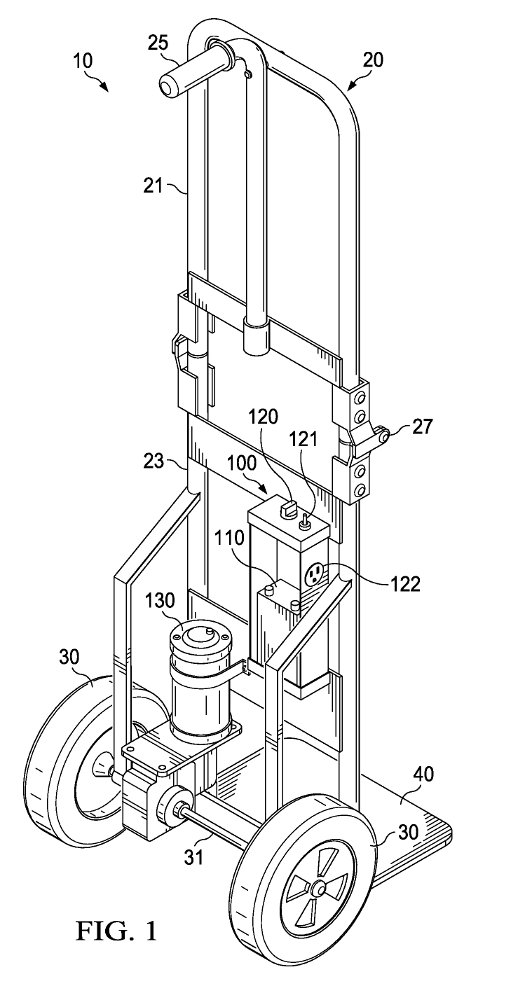

FIG. 1 is a perspective view of a portable, collapsible motorized hand truck in an expanded, upright mode in accordance with an embodiment of the present invention. Hand truck 10 includes a frame 20 having an upper frame portion 21, a lower frame portion 23, a foldable joint 27 connectedly positioned between said lower frame portion 23 and upper frame portion 21, and a handle 25 connected to frame 20 near the top of upper frame portion 21. Hand truck 10 also has at least one wheel 30 connected to frame 20 near the bottom of lower frame portion 23. Alternatively, a pair of wheels 30 may be mounted on an axle 31, with said axle 31 being connected to frame 20 near the bottom of lower frame portion 23. Hand truck 10 further has a folding support platform 40 hingedly or rotatably connected to frame 20 near the bottom of lower frame portion 23.

Further, hand truck 10 includes a drive compartment 100 disposed on lower frame portion 23. Drive compartment 100 houses at least one battery 110, a drive controller 120, and at least one motor 130 electrically connected to battery 110 and drive controller 120. At least one motor 130 may be mechanically connected to at least one wheel 30 or mechanically connected to axle 31 in order to provide driving force for the motorized hand truck. A main power switch 121 and a charging port 122 are preferably disposed on the drive compartment 100 and electrically connected to drive controller 120. In an alternate embodiment, at least one battery 110, drive controller 120, and at least one motor 130 may be mounted directly to frame 20 without use of drive compartment 100.

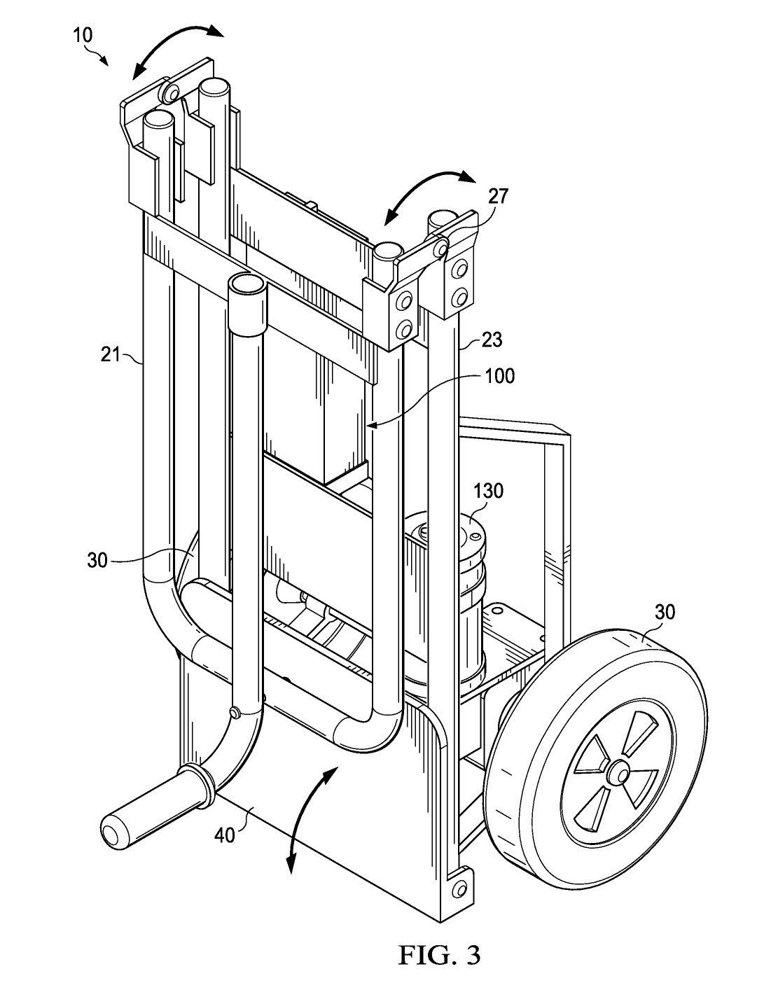

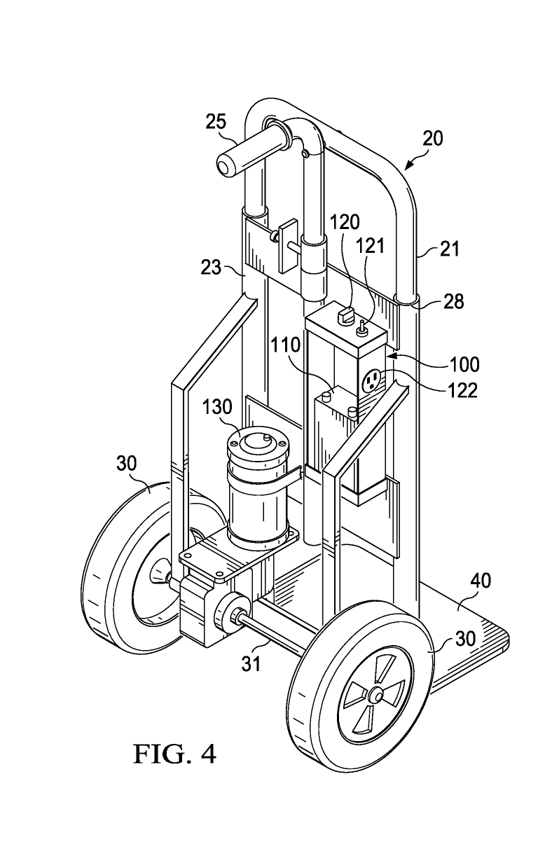

FIG. 3 is a perspective view of the hand truck 10 in the collapsed mode. As shown in FIG. 3, frame 20 is foldable and collapsible by folding upper frame portion 21 around folding joint 27 over upon lower frame portion 23. In an alternate embodiment, seen in FIG. 4, foldable joint 27 is replaced with slidable joint 28 which creates a slidable connection that permits upper frame portion 21 to slide into lower frame portion 23. In the collapsed mode, the size and volume occupied by hand truck 10 is significantly reduced, thereby facilitating efficient storage and ease of transport.

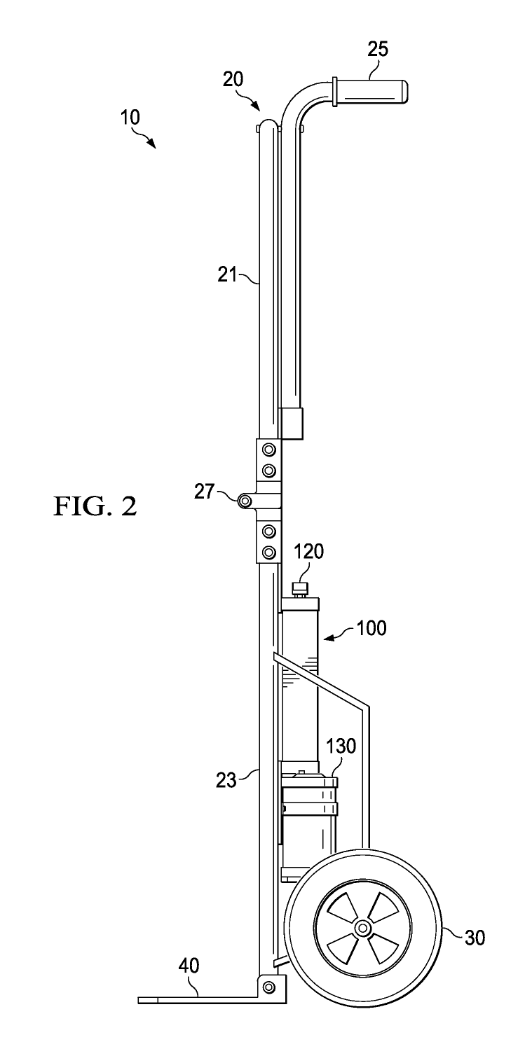

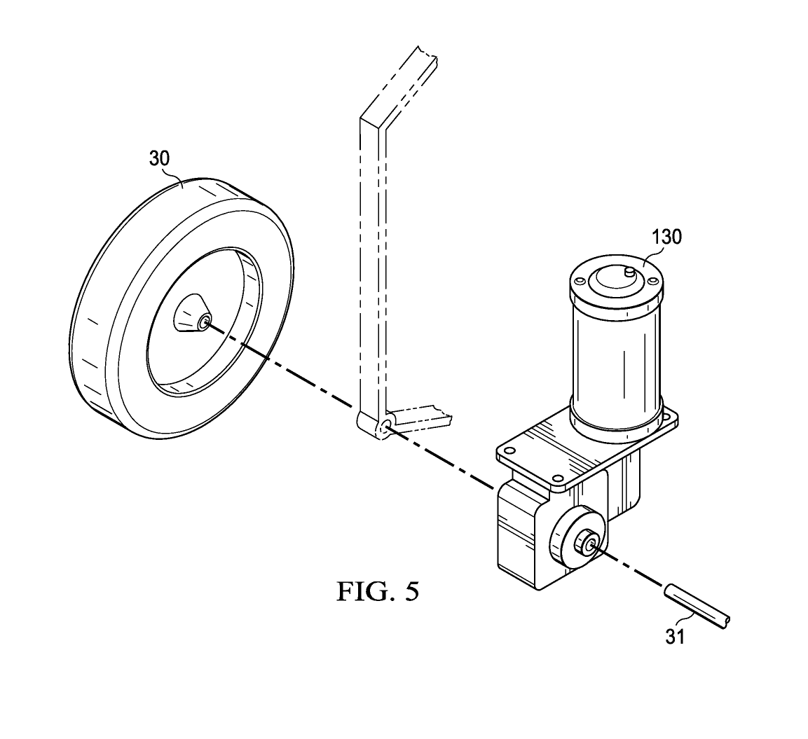

As seen in FIG. 1 and FIG. 2, a pair of wheels 30 may be mounted on an axle 31 that is connected to frame 20 at the lower end of lower frame portion 23. As seen in FIG. 5, at least one motor 130 may be mounted on frame 20 and connected to axle 31 by means of a drive belt, chain, gear or equivalent mechanism.

While various embodiments of the invention have been described, the description is intended to be exemplary, rather than limiting and it will be apparent to those of ordinary skill in the art that other embodiments and implementations are possible that are within the scope of the invention. Accordingly, the invention is not to be restricted except in light of the attached claims and their equivalents.

The invention claimed is:

1. A portable, collapsible, motorized hand truck comprising:
a frame having an upper frame portion, a lower frame portion, and a foldable joint connecting the upper frame portion to the lower frame portion;
a handle connected to the frame near the top of the upper frame portion;
at least one wheel connected to the frame near the bottom of the lower frame portion;
a support platform connected to said frame near the bottom of said lower frame portion;
a drive controller;
at least one battery;
at least one motor electrically connected to said battery and drivingly connected to said at least one wheel;
a power switch; and
a charging port.

2. The portable, collapsible hand truck of claim 1 wherein said support platform is rotatably connected to said frame near bottom of said lower frame portion.

3. A portable, collapsible, motorized hand truck comprising:
a frame having an upper frame portion, a lower frame portion, and a foldable joint connecting the upper frame portion to the lower frame portion;
a handle connected to the frame near the top of the upper frame portion;
an axle connected to said frame a pair of wheels connected to the axle;
a support platform connected to said frame near the bottom of said lower frame portion;
a drive controller;
at least one battery;
at least one motor electrically connected to said battery and drivingly connected to the axle;
a power switch; and
a charging port.

4. The portable, collapsible hand truck of claim 2 wherein said support platform is rotatably connected to said frame near bottom of said lower frame portion.

5. A portable, collapsible, motorized hand truck comprising:
a frame having an upper frame portion slideably connected to a lower frame portion;
a handle connected to the frame near the top of the upper frame portion;
at least one wheel connected to the frame near the bottom of the lower frame portion;
a support platform connected to said frame near the bottom of said lower frame portion;
a drive controller;
at least one battery;
at least one motor electrically connected to said battery and drivingly connected to said at least one wheel;
a power switch; and
a charging port.

6. The portable, collapsible hand truck of claim 1 wherein said support platform is rotatably connected to said frame near bottom of said lower frame portion.

7. A portable, collapsible, motorized hand truck comprising:
a frame having an upper frame portion slideably connected to a lower frame portion;
a handle connected to the frame near the top of the upper frame portion;
an axle connected to said frame a pair of wheels connected to the axle;
a support platform connected to said frame near the bottom of said lower frame portion;
a drive controller;
at least one battery;
at least one motor electrically connected to said battery and drivingly connected to the axle;
a power switch; and
a charging port.

8. The portable, collapsible hand truck of claim 2 wherein said support platform is rotatably connected to said frame near bottom of said lower frame portion.
